(19) United States
(12) Patent Application Publication
(10) Pub. No.: US 2024/0208828 A1
(43) Pub. Date: Jun. 27, 2024

(54) Nano-structured carbon coated silicon material and manufacturing method for use in lithium ion based secondary batteries

(71) Applicant: E-magy B.V., Broek op Langedijk (NL)

(72) Inventors: Axel Georg Schönecker, Broek op Langedijk (NL); Marco Alberto Spreafico, Haarlem (NL); Pierre-Yves Pichon, Noyal-sur-Vilaine (FR); Pierre Aymeric Fernand Berneron, Alkmaar (NL); Adrianus Maria Groenland, Heerhugowaard (NL); Bernard Jan Kraaijveld, Noord Scharwoude (NL)

(73) Assignee: E-magy B.V., Broek op Langedijk (NL)

(21) Appl. No.: 18/555,016

(22) PCT Filed: Apr. 14, 2022
(86) PCT No.: PCT/NL2022/050210

§ 371 Date: Oct. 12, 2023

(30) Foreign Application Priority Data
Apr. 15, 2021 (NL) 2027980

(51) Int. Cl. C01B 33/021; H01M 4/02; H01M 4/36; H01M 4/38; H01M 4/583; H01M 10/052

(52) U.S. Cl. CPC C01B 33/021; H01M 4/366; H01M 4/386; H01M 4/583; H01M 10/052; C01P 2004/03; C01P 2004/51; C01P 2004/61; C01P 2004/84; C01P 2006/40; H01M 2004/027

(57) ABSTRACT

The invention relates to a silicon-based material consisting of at least silicon particles where the silicon particles are nano-structured and micron sized, wherein the nano-porous structure of a particle includes oriented channels completely penetrating the silicon particle and connecting two opposite surfaces of the particle, and involves a method for manufacturing the silicon-based material consisting of at least silicon particles as described above, including creating a solidified eutectic metal-silicide silicon structure consisting of a metal silicide phase and a silicon phase by means of a controlled directional solidification process of an eutectic metal silicon melt, and forming nano-porous structured silicon by dissolving the metal silicide phase in the solidified eutectic metal-silicide silicon structure by a chemical etching process.

### FIELD OF THE INVENTION

The present invention relates to a method for manufacturing of silicon-based particles. Also, the invention relates to such particles where the particles have a nano-porous structure.

Moreover, the invention relates to an anode of a lithium based battery comprising the silicon material and a lithium based battery having such an anode.

### BACKGROUND

Silicon is a very high capacity lithium host material. It has a tenfold capacity to store lithium ions compared to graphite. Consequently silicon is useful as anode material in high energy density lithium ion based secondary batteries. The main obstacle for the application of silicon however is the high volume change associated with the lithium—silicon alloying process. This volume change causes mechanical failures in the silicon containing anode such as breakage of particles or disconnection of silicon particles from other materials in the anode or the metal electrode. To overcome such failures both anode composition as also the structure of the silicon in such anodes must be well designed.

It is known that silicon powders with particle sizes above ˜0.5 μm will break and crack when they are transformed into lithium silicon alloys under battery cycling. It is also known that nano-sized silicon structures can prevent crack formation during cycling.

Consequently nano-sized silicon powder can be cycled in a stable way once its particle size is below a stability limit of ˜150 nm-200 nm. However nano-sized silicon powders are very difficult to handle in industrial processes and expensive to produce on large industrial scale.

An approach to overcome the difficulties of handling nano-sized silicon powder in secondary batteries is to agglomerate the nano-sized silicon particles in micron-sized carbon particles (scaffolding particle, pomegranate particles). The disadvantage of such an approach is that it requires additional complex and expensive material processing steps and consequently results in a high cost material.

Another strategy to apply silicon in lithium ion based secondary batteries is the manufacturing of silicon as micrometer sized powder with an internal nano-structure to overcome the breakage problem. This approach can solve the mechanical issues such as crack formation during lithiation and disconnection of the silicon in the anode matrix. In the form of micron-sized particles, such silicon material is very well compatible with existing anode manufacturing processes.

Examples of such sub-micron structured porous silicon in lithium ion battery anodes are described in

US2018069234 (A1) Nexeon; Electroactive materials for metal-ion batteries;

US2015072240(A1) LG Chem; Porous silicon-based particles, method of preparing the same, and lithium secondary battery including the porous silicon-based particles.

These references disclose methods based on metal (Ag, Cu) assisted etching (US2018069234 (A1) and US2015072240(A1)) that is applied on micron-sized silicon particles. Such processes allow to partially convert such silicon material into nano-structured particles. Due to the nature of the etching process, the structured silicon particles consist of an ‘unstructured silicon’ core that is needed to prevent disintegration of the etched, structured part of the silicon.

The next step in the manufacturing of such silicon particles containing anodes is the formation of a slurry, that is then coated onto a metal foil using e.g. doctor blade- or slot die coating processes.

In more detail, the anode coating process includes mixing of the nano-sized structured silicon material with a binder material (e.g. poly-acrylic acid) and conductive carbons (e.g. carbon black, carbon nano-tubes or carbon fibers) in a solvent (e.g. water). It can also include the addition synthetic- or natural graphite powders. The materials are mixed with a solvent to gain a liquid slurry that can be coated onto a metal electrode (e.g. a copper foil). After a drying process such coated metal foil can be shaped to a certain size and combined with the other components, such as a separator layer and a cathode in a secondary battery.

These processes are well known and also described in e.g. Junying Zhang et al. High-Columbic-Efficiency Lithium Battery Based on Silicon Particle Materials, Nanoscale research letters, Issue: 1, Volume: 10, Pages: 395-395. Oct. 8, 2015.

While such process will yield a reasonably performing anode, the electrical resistance between silicon particles and the conductive carbons is often high. To improve the performance of such anode an additional silicon surface coating step can be applied. An example of an amorphous carbon coating produced in a high temperature carbonization process under argon is described e.g. in:

U.S. Pat. No. 9,559,355 B2, Hydro-Quebec, Particulate Anode Materials And Methods For Their Preparation.

Anodes where silicon is coated show superior performance with respect to battery lifetime and charging rate. A disadvantage is that the additional often high temperature coating step adds to the manufacturing costs of such anodes.

It is an object of the present invention to overcome or mitigate one or more of the disadvantages from the prior art.

### SUMMARY OF THE INVENTION

The object is achieved by a method for manufacturing silicon based particles in accordance with claim 1. The invention discloses a silicon material consisting of micron size particles where each of the particle has a nano-structure and a method to manufacture such silicon particles. In contrast to the prior art, the manufacturing method allows the particles to be completely structured, which overcomes the limitation of an unstructured volume within the particle to prevent disintegration. The nano-structure in such particles has the form of penetrating holes or channels that extend through a particle and connect two surfaces of the particle. Optionally if the channels branch within the particle, the channels can connect two or more surfaces. The channels are more effective in transporting liquid electrolyte into the silicon compared to prior art where holes with a single opening on one surface are disclosed. The improved electrolyte transport properties in combination with the complete structuring of the particles result in better battery performance, higher capacities and improved charging and discharging rates compared to prior art.

The manufacturing method also discloses a carbon coating that is applied to the silicon without the need for an additional process step. In the prior art, carbon coatings are applied using a high temperature carbonization or a coating step such as a chemical vapor deposition process. Such additional processing steps are made obsolete by the disclosed method.

Furthermore, the invention relates to a powder of silicon based particles in accordance with claim 13. Also, the invention relates to an anode for a secondary battery and to a lithium based secondary battery.

### BRIEF DESCRIPTION OF DRAWINGS

The invention will be explained in more detail below with reference to drawings in which illustrative embodiments thereof are shown. The drawings are intended exclusively for illustrative purposes and not as a restriction of the inventive concept. The scope of the invention is only limited by the definitions presented in the appended claims

FIG. 1 shows the layered structure of a lithium ion based secondary battery with its different components;

FIG. 2 shows the composition of an anode consisting of structured silicon, conductive carbon and binder on a metal electrode;

FIG. 3 shows a surface scanning electron microscope picture of a cross section of an anode that includes such structured silicon material;

FIG. 4 shows a surface scanning electron microscope picture of the sub-micron structures silicon powder particles;

FIG. 5 shows an example of a particle size distribution measurement of a micron sized, nano porous silicon particle sample with a median (D50) particle size of 7.9 mm;

FIG. 6A, 6B is a schematic drawing of a sub-micron structured silicon particle demonstrating the phase change geometry during the first charging of the secondary battery;

FIG. 7A, 7B is a schematic drawing of a sub-micron structured silicon particle in the charged—(left) and discharged (right) state;

FIG. 8 shows an X-ray photon emission spectroscopy spectrum of such micron sized silicon powder at energies close to the carbon C1s peak, and

FIG. 9 shows the charging—discharging efficiency—coulombic efficiency of nano-sized structured silicon material anodes in comparison to non-structured silicon material anodes.

### DETAILED TECHNICAL DESCRIPTION

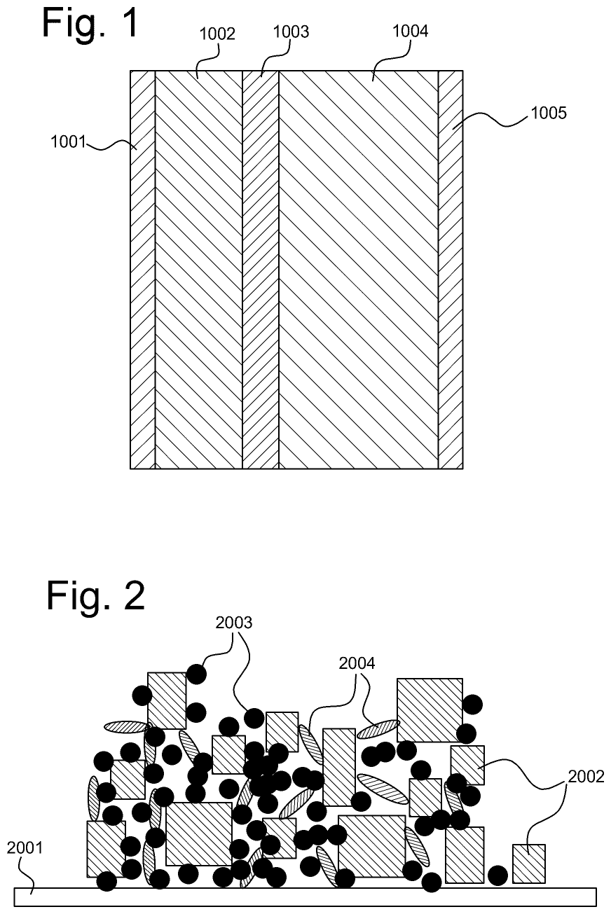

FIG. 1 shows the layered structure of a lithium ion based secondary battery with its different components.

Lithium ion based secondary batteries are made of a layered stack including an anode, separator and a cathode as schematically shown in FIG. 1. 1002 is an anode of a battery 1000 which in the case of this invention comprises mainly a nano-sized structured silicon material in combination with a binder material to improve mechanical stability and conductive additives to improve electrical conductivity. 1003 is a separator layer, which is made of electrically isolating material, which allows electrolyte penetration (e.g. porous polypropylene foil, or glass fiber cloth). The separator layer 1003 prevents a short circuit between anode 1002 and cathode 1004 which would result in a catastrophic failure of the secondary battery. 1004 indicates an active cathode layer which comprises a lithium containing metal oxide or metal phosphide with conductive additives to improve electrical conductivity and binder for mechanical stability. The secondary battery stack is filled with a lithium ion containing electrolyte 1005.

During charging of the battery 1000, lithium ions are extracted from the cathode 1004 and transported and stored in the anode 1002. During discharging of the battery 1000 the anode 1002 releases the stored lithium ions which are transported back into the cathode 1004. It is obvious that the overall energy density of the battery 1000 with stacked anode and cathode layers 1004, 1002 is mainly given by the specific lithium storage capacity of the materials in the anode and the cathode and their chemical potential with respect to the Li/Li+ transition. Therefore it is preferential to use cathode- and anode materials with a high specific capacity for lithium ion and a large potential difference.

An example of an advanced anode material is silicon with an approximately tenfold increased specific capacity compared to graphite. The silicon material can be transformed into a Li_{3.75}Si alloy with a specific capacity of 3590 mAh/g.

However the process of converting silicon into Li_{3.75}Si and vice versa causes large volume expansion and contraction of the silicon material during each battery cycle. The volume change causes mechanical stress in the silicon material itself and in the surrounding anode structure and consequently results in a rapid capacity fading of the battery.

In order to overcome such failure both the silicon material as also the interaction with the other components in the anode have to be designed in a way that the silicon material volume expansion can be mitigated during cycling. This measure would have the result that the anode and thus the battery is stabilized.

The first embodiment of this invention describes a method to manufacture the silicon material, including an advantageous carbon surface coating of the silicon and its application in a high energy density lithium ion secondary battery system.

The method described in detail below consists of three processing steps:
Step 1: A rapid directional solidification of a metal—silicon melt at—or close to a melt composition of the eutectic ratio of the metal—silicon system into a solid binary phase material consisting of a metal silicide phase and a silicon phase
Step 2: Dissolving the metal silicide phase from the solidified material using a wet chemical etching step followed by
Step 3: Material milling of the etched solidified material in contact with a carbon containing material.

The details of these three steps are described as follows:

The first step in the silicon material manufacturing method involves a rapid directional solidification step of a liquid silicon—metal containing melt. As an example of the embodiment the process is described in the form of a liquid silicon—chromium melt, however silicon in combination with other metals such as e.g. titanium or vanadium and others can be used as alternatives.

When a liquid melt with a composition at or close to the eutectic ratio of chromium and silicon is rapidly solidified, a phase separation takes place and a two phase structure is solidified in form of a lamellar structure of a chromium di-silicide and a silicon phase. A model that describes the structural geometry in dependence of the crystallization velocity was published by Jackson and Hunt (Jackson K. A., Hunt J. D., Lamellar and rod eutectic growth [J]. Trans Met Soc AIME, 1966, 236: 1129-1142.)

The lamellar or rod like formed silicide and silicon phases extend in the direction of the crystallization front movement and have a typical dimension (defined as distance between a chromium disilicide phase and the consecutive silicon phase) that is dependent on the crystallization velocity. Therefore a well-controlled crystallization process that allows a close to constant crystallization velocity can be used as method to manufacture such homogenously spaced chromium disilicide—silicon materials.

A preferred crystallization process for this method is e.g. described in DE3419137 (A1) for semiconductor foils, in which an undercooled substrate is transported underneath a casting frame filled with the eutectic composition melt. The crystallization process starts when the undercooled substrate comes in contact with the melt in the casting frame and continues during the transport time of the substrate in contact with the melt. Due to the crystallization direction vertically to the plane of the substrate surface, the lamellar or rod like structure is also oriented vertically to the substrate surface. As this process allows for a high, well controlled crystal growth velocity, eutectic chromium-silicon melts will crystallize with a well-defined oriented eutectic two phase structure. The controllable crystallization velocity of the casting process in combination with an chromium—silicon eutectic melt results in a structured two phase material where the structural dimension (i.e. the characteristic distance between a pair of parallel silicon lamellae) can be adjusted in a technically relevant range between 100 nm and 1500 nm by changing the thermal contact with the substrate and the temperature difference between substrate and melt.

The second step of the method involves a selective etching (and removal) of the metal-silicide. Most metal-silicides can be etched in diluted hydrogen fluoride solutions. As hydrogen fluoride does not react with silicon a selective etching process is established. As a result of such process, sheets of material are obtained where the metal-silicide phase is removed and a nano-porous silicon structure is obtained.

The etching process can be performed at room temperature, however higher temperature might be useful to increase chemical reactivity. The concentration of the hydrogen fluoride solution can be adjusted to improve the process yield and shorten processing time and optimize the use of the etchant in the process. It is also known that most of the reaction components can be recycled in the form of metal oxide, silicon oxide and hydrogen fluoride. Consequently the etching process is very well suited to produce nano-porous structured silicon material in a circular process with minimum waste of by-products.

As a last step of the etching process, the etched silicon material is removed from the etchant and rinsed in water.

The last step comprises milling of the etched nano-structured silicon material to obtain micron-sized silicon powder. Ball- or drum milling are methods that can be applied in this process in dependence of the intended production volume, however continuous milling processes with selective particle size filtering such as jet-milling may be preferred for larger scale production.

While the milling will produce a micron-sized silicon powder material with the desired nano-structure porosity, it will not yield the optimum electrical conductivity when the milled silicon material is included in an anode coating.

FIG. 4 shows a surface scanning electron microscope picture of the sub-micron structures silicon powder particles in the micron-sized silicon powder. A typical average particle size is between 1 □m-20 □m. The nano-size structure of the particle shows oriented channels that extend through the particle and connect two surfaces of the particle with a typical channel dimension between 100 nm and 500 nm in this example. The orientation of the channels can be seen in the form of holes on surfaces 4001, respectively channels at surfaces 4002 depending on the particle orientation in the picture.

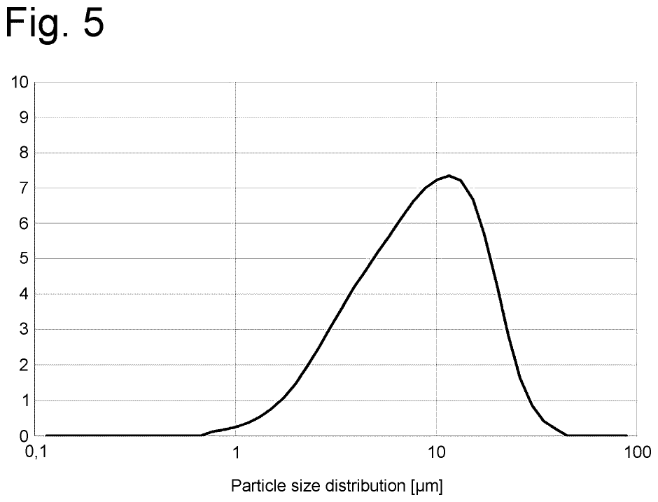

FIG. 5 shows an example of a particle size distribution of such micron-sized silicon powder. In this example the average particle size (D50) is 7.9 □m, while D10=2.7 □m, D90=17.5 □m. It will be appreciated that the particle size distribution can be adjusted in the milling process. For practical reasons in the battery manufacturing process, it is preferable to have an average particle size between 1 □m and 20 □m.

According to the embodiment of this invention, the milling of the silicon material is executed in contact with a carbon containing material. Such carbon containing material can comprise at least one of carbon black, graphite, hard carbon, carbon nano-tubes, graphene, acetylene black, carbon fibers, but is not limited thereto.

In the milling process, silicon sheet material is continuously broken, creating silicon surfaces with reactive dangling bonds. The dangling bonds can react with carbon containing material included in the milling process or carbon containing milling equipment components to form silicon carbide bonding with carbon containing agglomerates or particles. The carbon containing agglomerates or particles thus consist of carbon containing material that is chemically bonded to the surface of the silicon particles. Possibly, the carbon containing agglomerates or particles form a coating layer that is partially or fully covering the external surface of the silicon particles.

As an example, the addition of 1%_{wt}, to 10%_{wt}, of carbon black during the milling step shows to improve conductivity between the silicon particles and the anode structure and increase cycle lifetime of batteries produced with such anodes.

It is preferable to do the milling step in a dry milling process to allow contact between the dangling bonds in freshly broken silicon and the carbon containing material. In a wet milling process dangling bonds at the silicon surface have a high probability to react with the wet environment, while in a dry milling process the chemical bonding to conductive carbon particles is more likely.

Another improvement is the execution of the milling step under a protective gas atmosphere e.g. under a gas such as argon. The protective gas atmosphere will hinder the competing reaction of the silicon dangling bonds with atmospheric oxygen.

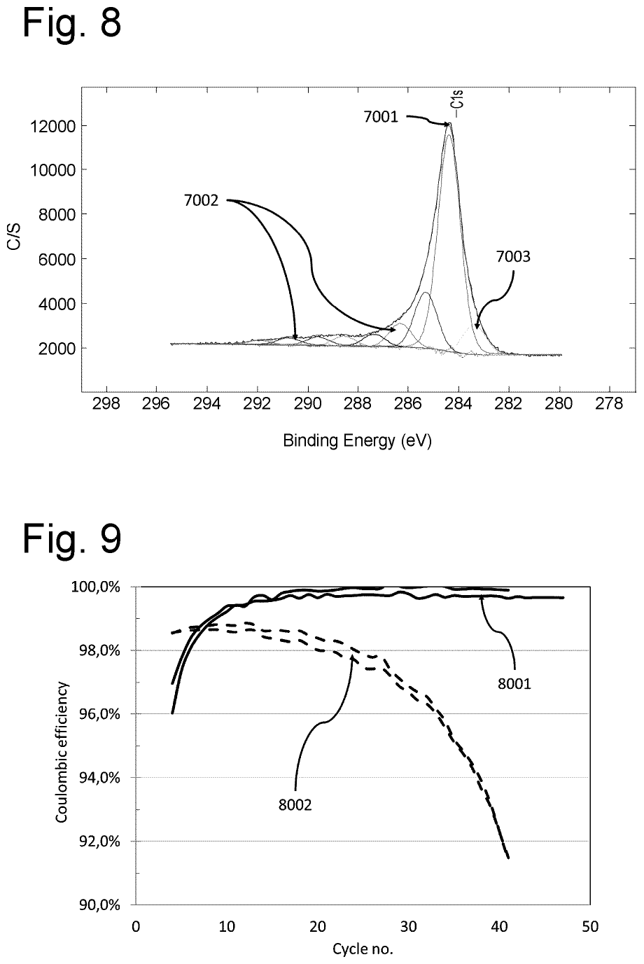

FIG. 8 shows an X-ray photon emission spectroscopy spectrum at energies close to the carbon C1s peak 7001 of a sub-micron structured silicon powder as produced according to the invention and milled in contact with a carbon black powder. The higher energy sections in the spectrum 7002 show the existence of C—O bonds, the lower energy section 7003 shows the existence of Si—C bonds. In this example the carbon black particles are chemically bonded to the silicon surface in the form of a carbon coating.

The combination of milling the silicon material and the exposure to carbon material yields a nano-structured, micron-sized carbon coated silicon material which shows improved performance when combined with other components in the anode of lithium ion secondary batteries. The greatly improved conductivity of the silicon material in the anode increases the performance of the anode while the nano-structure of the silicon allows for a stable electrical cycling and prevents crack formation or anode delamination as will be shown in the application examples below.

In another embodiment the etching and milling step order is reversed. It is possible to first perform a milling step on the solidified two-phase material to produce a powder that consists of particles with a metal-silicide—silicon two phase structure. In a way similar to the description in the embodiment above, carbon—silicon bonding can be achieved. After the milling step, the powder is selectively etched in a process as described above. This dissolves the metal-silicide phase and produces a nano-porous structure silicon material according to this invention.

According to an embodiment an additional mechanical fracturing step is added after the solidification step to produce metal-silicide—silicon pieces from the cast of solidified material. This additional step may be advantageous to provide material pieces that can be handled more efficiently in the successive chemical processing.

According to an embodiment the reaction with carbon containing material during the milling step can be omitted to produce a nano-structured silicon particle. In this case, the nano-structured silicon particle will typically form a natural silicon oxide surface. Nano-structured silicon particles having a natural silicon oxide surface can be useful e.g. in combination with coating processes that rely on the existence of a silicon oxide surface to react with organic molecules.

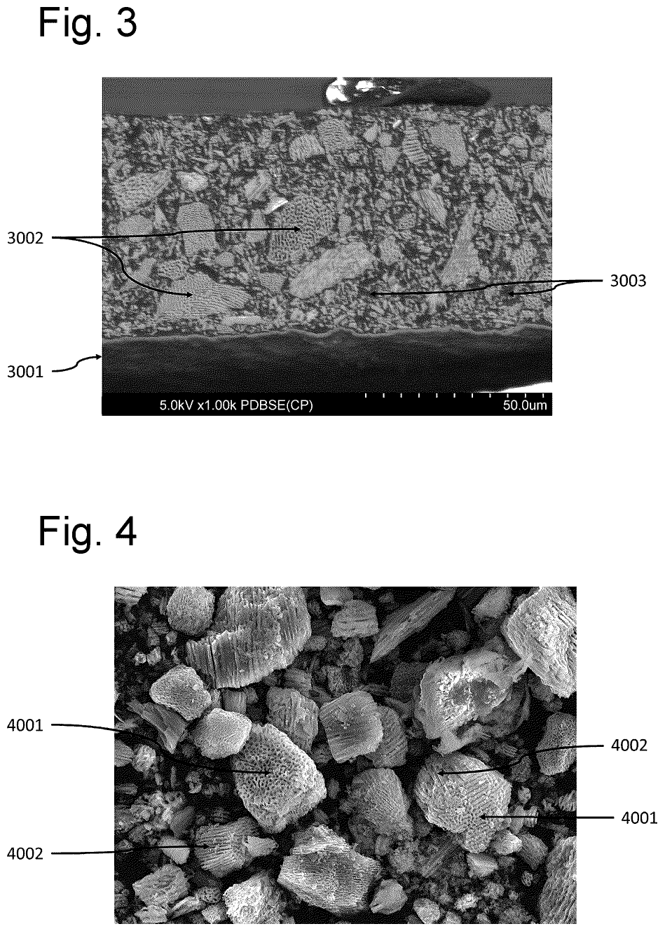

### Example (FIG. 3)

An example of such silicon material containing anode is shown in FIG. 3. A surface scanning electron microscope cross section is shown of an anode including structured silicon material 3002, carbon black 3003 and binder on a copper foil 3001.

The composition of the anode in this example contains 80%_{wt}, of nano-porous structured silicon that has been milled in contact with 5%_{wt}, of carbon black. During the slurry preparation in a polyacrylic acid solution 5%_{wt} of graphite powder was added. The final anode composition consist of 80%_{wt} silicon, 5%_{wt} carbon black, 5%_{wt} graphite and 10% c, polyacrylic acid.

If a silicon containing anode of this composition is combined with e.g. a lithium nickel manganese cobalt oxide cathode (NMC) it is preferable to match the capacity of anode and cathode in a way that the silicon containing anode is charged to a specific capacity between 1000 mAh/g and 2000 mAh/g well below the maximum capacity of silicon at 3590 mAh/g.

Accordingly, such matching would be to combine the silicon containing anode of this example with a lithium nickel manganese cobalt oxide cathode (NMC) of an areal capacity of 3 mAh/cm². If the areal loading of the silicon is adjusted to e.g. 1.5 mg/cm² or 3 mg/cm² the silicon material will operate at a specific capacity of 2000 mAh/g (1.5 mg/cm² loading) respectively at 1000 mAh/g (3 mg/cm² loading). This application of the silicon material containing anode has great advantages with respect to cycle lifetime and stable battery performance.

It is observed that silicon undergoes two phase changes when it is alloyed with lithium. Silicon first transforms into an amorphous Li_{3.4}Si phase before it converts into the crystalline Li_{3.75}Si. If lithiation is limited well below the Li_{3.4}Si ratio (ca. 3200 mAh/g), a two phase material exists where one part of the silicon material is converted into Li_{3.4}Si, while another part of the silicon remains in its crystalline state.

The advantage of this use of silicon (i.e., capacity limited loading (limited lithiation as mentioned above)) is that the remaining crystalline silicon phase will mechanically stabilize the silicon particles and force the expansion of the silicon into the internal porosity of the particles. This effect drastically reduces the mechanical load on the anode composition and increases battery cycling stability. It also prevents external swelling of the silicon anode containing battery which is one of the major hurdles in applying silicon dominant anodes.

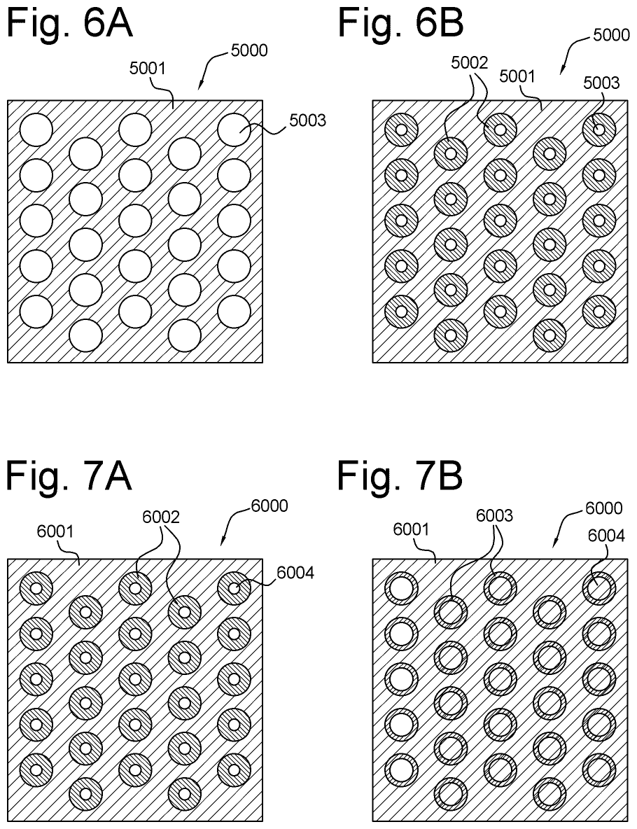

The effect of the capacity limited loading is explained in more detail with reference to FIGS. 6A, 6B and 7A, 7B. FIG. 6A, 6B shows a schematic drawing of a sub-micron structured silicon particle during the first charging. The pristine silicon particle 5000 (FIG. 6A) consists of a pure crystalline silicon phase 5001. During the first charging cycle, crystalline silicon is converted into an amorphous Li_{3.4}Si phase 5002. During the first charging both crystalline silicon (silicon phase) 5001 and amorphous Li_{3.4}Si phase 5002 co-exist together (FIG. 6B). Depending upon the amount of lithiation the material can be completely converted into the amorphous Li_{3.4}Si phase. At even higher lithiation, silicon alloys with composition Li_{3.75}Si will occur. In the case of a capacity limited cycling well below the capacity of the complete conversion to the Li_{3.4}Si phase, the two phases in the material will continue to co-exist.

FIG. 7A, 7B shows a schematic drawing of a sub-micron structured silicon particle 6000 during consecutive charged (FIG. 7A) and discharged (FIG. 7B) state under a capacity limited battery cycle. The lithium containing (charged) silicon particle consists of the two phases, crystalline silicon 6001 and amorphous Li_{3.4}Si 6006. After discharging, the amorphous Li_{3.4}Si phase is converted into amorphous silicon 6003. During consecutive battery cycling at the same or lower capacity only the amorphous silicon—Li_{3.4}Si volume is active. The remaining crystalline silicon 6001 does not significantly change and will mechanically stabilize the (porous) particle.

FIG. 9 shows the charging—discharging efficiency—coulombic efficiency of silicon material anodes. Reference 8001 indicates the coulombic efficiency versus cycle for two samples containing nano-structured silicon material according to this invention. Reference 8002 indicates the coulombic efficiency versus cycle development for micron-sized, non-structured silicon. Both materials had identical particle size distribution and anode composition. Anodes were prepared using 80%_{wt} of silicon with 10%_{wt} conductive carbons and 10%_{wt} polyacrylic acid as a binder. The cycling was done against a lithium metal disk with a capacity limitation of 1000 mAh/g of silicon. Test cycles with two hours charging and two hours discharging time were used for all samples.

This example demonstrates the application of the nano-structure, micron-sized, carbon coated particle that is produced with the method in accordance with an embodiment of this invention.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims.

1. A method for manufacturing silicon-based particles, comprising
creating a eutectic metal-silicon melt from a metal and silicon as constituents;
bringing the eutectic metal-silicon melt in contact with an undercooled substrate, while controlling a time in which the substrate is in contact with the melt so as to create a solidified eutectic metal-silicide silicon plate or flake consisting of a metal silicide phase and a silicon phase by means of a controlled directional solidification process of the eutectic metal silicon melt, in which a lamellar or rod like eutectic casting structure of lamellae or rods of the silicon phase and lamellae or rods of the metal-silicide phase parallel to each other in a direction perpendicular to the substrate is formed;
create nano-structured and micron-sized silicon based particles by exposing the solidified eutectic metal-silicide silicon plate or flake to a milling step and an etching step wherein the etching step comprises exposure to a selective chemical etching process configured to dissolve the lamellae or rods of the metal silicide phase in the directionally solidified lamellar or rod like eutectic casting structure and to form parallel oriented channels in the silicon phase at the location of the dissolved lamellae or rods of the metal silicide phase, such that the silicon based particles are each configured at the location of each dissolved lamella or rod of the metal silicide phase with a channel completely penetrating the silicon based particle and connecting at least two surfaces of the silicon based particle.

2. The method according to claim 1, wherein the silicon based particles have multiple channels oriented parallel to each other between the at least two surfaces.

3. The method according to claim 1, further comprising that the step of milling the solidified eutectic metal-silicide silicon plate or flake is subsequent to the etching step.

4. The method according to claim 1, further comprising that the step of milling the solidified eutectic metal-silicide silicon plate or flake precedes the etching step.

5. The method according to claim 1, wherein the milling process is selected from a group comprising ball milling, drum milling, jet milling.

6. The method according to claim 3, further comprising, when the milling step is subsequent to the etching step:—providing during the milling process chemically bonding of carbon-based agglomerates on an exterior surface of the silicon based particles by adding a carbon containing material comprising at least one selected from a group comprising carbon black, graphite, hard carbon, carbon nano-tubes, graphene, acetylene black, and carbon fibers.

7. The method according to claim 6, comprising the creation of carbon-based agglomerates or carbon based particles on exterior surfaces of the silicon based particles.

8. The method according to claim 7, comprising a creation of a silicon-carbide layer arranged between the exterior surfaces of the silicon based particles and the carbon-based agglomerates or carbon based particles.

9. The method according to claim 1, wherein the metal in the metal silicon melt is chromium and a crystallization velocity of the eutectic metal silicide silicon structure during the controlled directional solidification is equal to or above 0.1 mm/s.

10. The method according to claim 1, wherein the parallel oriented channels in the silicon based particles have a diameter between 100 nm and 1000 nm.

11. The method according to claim 1, wherein walls between two parallel oriented channels in the silicon based particles have a minimum thickness between 100 nm and 1000 nm.

12. (canceled)

13. A powder of silicon based particles manufactured by a method comprising the steps of:
creating a eutectic metal-silicon melt from a metal and silicon as constituents;
bringing the eutectic metal-silicon melt in contact with an undercooled substrate, while controlling a time in which the substrate is in contact with the melt so as to create a solidified eutectic metal-silicide silicon plate or flake consisting of a metal silicide phase and a silicon phase by means of a controlled directional solidification process of the eutectic metal silicon melt, in which a lamellar or rod like eutectic casting structure of lamellae or rods of the silicon phase and lamellae or rods of the metal-silicide phase parallel to each other in a direction perpendicular to the substrate is formed;
create nano-structured and micron-sized silicon based particles by exposing the solidified eutectic metal-silicide silicon plate or flake to a milling step and an etching step wherein the etching step comprises exposure to a selective chemical etching process configured to dissolve the lamellae or rods of the metal silicide phase in the directionally solidified lamellar or rod like eutectic casting structure and to form parallel oriented channels in the silicon phase at the location of the dissolved lamellae or rods of the metal silicide phase, such that the silicon based particles are each configured at the location of each dissolved lamella or rod of the metal silicide phase with a channel completely penetrating the silicon based particle and connecting at least two surfaces of the silicon based particle.

14. The powder of claim 13, wherein the silicon based particles are micron sized, and each have a nano-porous structure comprising at least one channel completely penetrating the silicon based particle and connecting at least two surfaces of the silicon based particle.

15. The powder of claim 13, wherein the silicon based particles are micron sized, and each have a nano-porous structure comprising multiple channels completely penetrating the silicon based particle and oriented parallel to each other between at least two surfaces of the silicon based particle.

16. The powder according to claim 15, wherein the parallel oriented channels have a diameter between 100 nm and 1000 nm.

17. The powder according to claim 13, wherein walls between the parallel oriented channels have a minimum thickness between 100 nm and 1000 nm.

18. The powder according to claim 13, wherein carbon-based agglomerates or carbon-based particles are present on exterior surfaces of the silicon based particles.

19. The powder according to claim 18, wherein the silicon based particles comprise a silicon-carbide layer arranged between the exterior surfaces of the silicon based particles and the carbon-based agglomerates or carbon-based particles.

20. (canceled)

21. A lithium based secondary battery with an anode,
wherein the anode comprises a silicon-based material consisting of at least silicon-based particles where the silicon based particles are medium sized, and have a nano-porous structure comprising parallel oriented channels completely
penetrating the silicon based particle, and connecting two opposite surfaces of the particle
wherein the silicon-based particles are manufactured by a method comprising the steps of
creating a eutectic metal-silicon melt from a metal and silicon as constituents;
bringing the eutectic metal-silicon melt in contact with an undercooled substrate, while controlling a time in which the substrate is in contact with the melt so as to create a solidified eutectic metal-silicide silicon plate or flake consisting of a metal silicide phase and a silicon phase by means of a controlled directional solidification process of the eutectic metal silicon melt, in which a lamellar or rod like eutectic casting structure of lamellae or rods of the silicon phase and lamellae or rods of the metal-silicide phase parallel to each other in a direction perpendicular to the substrate is formed;
create nano-structured and micron-sized silicon based particles by exposing the solidified eutectic metal-silicide silicon plate or flake to a milling step and an etching step wherein the etching step comprises exposure to a selective chemical etching process configured to dissolve the lamellae or rods of the metal silicide phase in the directionally solidified lamellar or rod like eutectic casting structure and to form parallel oriented channels in the silicon phase at the location of the dissolved lamellae or rods of the metal silicide phase, such that the silicon based particles are each configured at the location of each dissolved lamella or rod of the metal silicide phase with a channel completely penetrating the silicon based particle and connecting at least two surfaces of the silicon based particle in combination with a cathode layer wherein a capacity of the cathode is chosen in a way that the anode is charged to a maximum capacity in which silicon based particles are only partially alloyed to an amorphous Li3.4Si phase and wherein a remainder of each silicon based particle consists of a crystalline silicon phase next to the amorphous Li3.4Si phase.

22. The lithium based secondary battery according to claim 21, wherein the amorphous Li3.4Si phase is formed as a layer on the walls of the parallel oriented channels in the silicon based particles and the formed amorphous Li3.4Si phase is enclosed in the silicon based particles by the crystalline silicon phase.

23. The lithium based secondary battery according to claim 21, wherein a capacity of the cathode is chosen in a way that the anode is charged to a capacity of less than 2500 mAh/g of silicon.
